(19) United States
(12) Patent Application Publication
(10) Pub. No.: US 2025/0010370 A1
(43) Pub. Date: Jan. 9, 2025

(54) PROCESS FOR MANUFACTURING A POROUS TRANSPORT LAYER

(71) Applicant: BASF SE, Ludwigshafen am Rhein (DE)

(72) Inventors: Sherif Aly Hassan Aly MADKOUR, Ludwigshafen am Rhein (DE); Daniel MALKO, Ludwigshafen am Rhein (DE); Benjamin SCHMIDT-HANSBERG, Ludwigshafen am Rhein (DE)

(21) Appl. No.: 18/699,938

(22) PCT Filed: Oct. 7, 2022
(86) PCT No.: PCT/EP2022/077923

§ 371 Date: Apr. 10, 2024

(30) Foreign Application Priority Data
Oct. 15, 2021 (EP) 21203001.9

(51) Int. Cl. C25B 13/02; C25B 13/04

(52) U.S. Cl. CPC C25B 13/02; C25B 13/04

(57) ABSTRACT

The invention relates to a process for manufacturing a multilayered porous transport layer, the process comprising
(a) providing a first feedstock comprising first metal particles and a first polymer binder; and providing a second feedstock comprising second metal particles and a second polymer binder;
   the first and the second feedstock having a metal powder content of 40 to 70% by volume; and
   the first feedstock having
   (i) metal particles with a smaller average particles size,
   (ii) a higher metal powder content, or
   (iii) both, metal particles with a smaller average particles size and a higher metal powder content
   compared to the second feedstock;
(b) coextruding the first and the second feedstock to form a film-shaped green body comprising a first layer and a second layer, the second layer being materially connected to the first layer above the melting temperature and or glass transition temperature of the first polymer binder and the second polymer binder;
(c) optionally smoothening the film-shaped green body by rolling or calendering;
(d) debinding the film-shaped green body to form a brown body;
(e) sintering the brown body under a non-oxidative atmosphere or vacuum and a temperature of from 700 to 1300° C. to form the porous transport layer;
wherein the first feedstock and the second feedstock are free of any solvents.

The invention relates to a process for manufacturing a porous transport layer for an electrochemical cell, in particular for an electrolyser of the PEM construction type, and specifically in particular for the electrolytic splitting of water into oxygen and hydrogen.

### BACKGROUND OF THE INVENTION

Proton exchange membrane (PEM) based electrolysis requires an electrochemical stable, electron conductive and gas permeable transport layer. In the most basic sense, porous transport layers (“PTLs”)—on the anode side of the electrolyzer—function is to homogenously distribute the water reactant to the catalyst layer and efficiently remove and diffuse evolving oxygen developing at the catalyst/PTL interface out of the PTL and in direction of the bipolar plate. PTLs on the anode side of the electrolyzer, require large contact area to the catalyst layer of the electrode, to improve the catalyst utilization and thus better electrolysis performance. At the same time, the PTLs need to have low pressure drop to facilitate the gas and water transport on the anode side. The two parameters of large contact area and low-pressure drop are contradictory which is a complex optimization topic to achieve best overall performance. Various work was proposed to overcome this challenge.

JP 2001-279481 A discloses a method of manufacturing a sintered body by forming a plurality of sheet-like objects having different particle diameters of titanium powder and a mixing ratio of a titanium powder and a binder, sintering the plurality of sheet-like objects in a laminated state. According to such a method, it is possible to manufacture a powder sintered body in which powder sintered portions having different porosities are laminated.

US 2006/0201800 A discloses a method of producing a porous electrical conductor for use in an electrochemical reaction membrane apparatus comprising an electrochemical reaction membrane, comprising the steps of: providing a sintered body of metal powder having a plate shape; forming a ground surface by a grinding process on a side of said sintered body of metal powder that faces the electrochemical reaction membrane when the electrolysis apparatus is assembled; and removing deformation portions on said ground surface formed during the grinding process by an etching process after the grinding process to increase the porosity of said porous electrical conductor on the side facing the electrochemical reaction membrane.

JP 2011-099146 A discloses a sintered metal sheet material made of a metal sintered compact prepared by sintering a metal powder and has a plurality of pores dispersed therein with a porosity ratio of 10-50 vol. %. The average pore diameter of the pores is 1-30 μm and some of the plurality of pores have their openings at a surface of the sintered metal sheet material.

Adv. Eng. Mater. 2019, 21, 1801201 discloses the manufacturing of large-scale titanium-based PTL for polymer electrolyte membrane electrolysis by tape casting.

WO 2020/20467 A1 discloses a method for producing a porous transport layer the method consisting of mixing a metal powder with a binder and subsequently forming same into a foil. The foil is laid on a porous metal layer, the binder is then removed, and the remaining brown sublayer is sintered to the porous metal layer, producing a PTL which has a porous metal layer with a microporous metal layer applied thereon.

US 2010/038809 A 1 discloses a process for manufacturing a multilayered porous tubular and/or sheet filtration membrane. The process comprises an apparatus and a method of producing lengths of multi-layered asymmetric membrane by way of coextruding different feedstock where each hopper contains a different mixture through a die head having a plurality of outlet ports. The mixture used is based on a binder dissolved in solvent and later mixed with powder. The mixtures are either with different powder/binder ratio and/or different metal powder grain size, where the different mixtures contain metal powders with different melting points. Following the extrusion, the extrudate is immersed is a liquid once it has emerged from the die head and further treatment includes the sintering of the multilayered extrusion in a furnace.

The current state of the art discusses a 2-layered PTL manufacturing method, which involves shaping the green part into two separate layers through extrusion, pressing, or any sort of forming and then placing them, either on an already finished metal porous layer or another green part. The placement and alignment of the two layers on top of one another is not only non-trivial and adds an extra processing step, but could also induce internal stress at the interface between the two the brought-together layers, which could result in poor mechanical properties and defects in the end sintered PTL, e.g. inner cracks, bumps or warpage of the surface. Such defects are well-known in the MIM industry, e.g from Hwang, K. S. Common defects in metal injection molding (MIM), the handbook of metal injection molding, Woodhead, 2012, 235-250. Furthermore, it is known from iScience 23, 101783, Dec. 18, 2020 that the stacking of two layers on top of one another creates a highly porous band in the middle of the PTL which allows for oxygen to merge and to form a periodic waveform, which would negatively influence the water transport properties of the PTL, especially at high current densities.

According to International Journal of Refractory Metals & Hard Materials 89 (2020) 105214, other processing methods from neighboring technical fields, e.g. membrane filters processing methods, utilizing binder/metal powder mixtures rely on specific binder systems suitable for solvent and/thermal debinding of the binder system. These do not only require high energy consumption and long debinding times, but also do not support good surface flatness for a porous transport layer with large dimensions in an electrochemical cell application. The surface flatness is key to improve contact with catalyst layer and insure proper pressure distribution in the electrochemical cell stack. Furthermore, as titanium is preferably used for such applications, it needs to be noted that titanium sintering is extremely sensitive to interstitial elements like carbon, hydrated oxides traces, chlorine impurities as well as gas such as water, carbon monoxide, carbon dioxide, oxygen or oxygen-chlorine complexes, which becomes detrimental to the mechanical properties of end part,

Hence, it would be beneficial to the performance and the quality of the PTLs to get rid of these drawbacks.

The object underlying the present invention is to provide a porous transport layer that show better water and oxygen transport properties, mechanical properties, and less defects in the end sintered PTL, particularly to reduce inner cracks, bumps or warpage of the surface. It is a further object of the invention to provide a cheaper way of manufacturing a PTL with different porosities across the PTL. It is also an object of the present invention to provide a PTL having a least two layers that do not show any discontinuities like a highly porous band in the transition phase between the two layers.

### SUMMARY OF THE INVENTION

A first aspect of the present invention is a process for manufacturing a multilayered porous transport layer, the process comprising
(a) providing a first feedstock comprising first metal particles and a first polymer binder; and providing a second feedstock comprising second metal particles and a second polymer binder;
   the first and the second feedstock having a metal powder content of 40 to 70% by volume; and
   the first feedstock having
   (i) metal particles with a smaller average particles size,
   (ii) a higher metal powder content, or
   (iii) both, metal particles with a smaller average particles size and a higher metal powder content
   compared to the second feedstock;
(b) coextruding the first and the second feedstock to form a film-shaped green body comprising a first layer and a second layer, the second layer being materially connected to the first layer at temperatures above the melting temperature and or glass transition temperature of said first polymer binder and second polymer binder;
(c) optionally smoothening the film-shaped green body by rolling or calendering;
(d) catalytically debinding the film-shaped green body to form a brown body;
(f) sintering the brown body under a non-oxidative atmosphere or vacuum of 104 mbar or below and a temperature of from 700 to 1100° C. to form the porous transport layer;
wherein the first feedstock and the second feedstock are free of any solvents.

The PTLs manufactured by using the process according to the invention show better water and oxygen transport properties, mechanical properties, and less defects in the end sintered PTL. In particular, it reduces inner cracks, bumps and warpage of the surface of the PTL. Furthermore, the process provides a cheaper way of manufacturing a PTL that has las two or more layers of different porosity. More specifically, the invention provides a PTL comprising at least two layers of different porosity without any discontinuity, particularly without any highly porous band in the transition phase between the two layers of the PTL.

The method according to the invention may be used to manufacture a porous transport layer for an electrochemical cell, for example for a battery, for a fuel cell or for an electrolyser.

A further embodiment of the present invention is a combination of a first feedstock and a second feedstock,
(a) the first feedstock comprising first metal particles and a first polymer binder;
(b) the second feedstock comprising second metal particles and a second polymer binder;
   the first feedstock having
(i) metal particles with a smaller average particles size,
(ii) a higher metal powder content, or
(iii) both, metal particles with a smaller average particles size and a higher metal powder content
compared to the second feedstock; and
wherein the melt flow rate MFR according to ISO 1133-1 using 190° C. and 2.16 kg of the first and the second polymer binder is from 1 to 5 g/10 min.

A further embodiment of the present invention is a film-shaped green body obtainable by performing steps (a) to (d) of the process according to the invention.

A further embodiment of the present invention is a porous transport layer obtainable by the process according to the invention.

### BRIEF DESCRIPTION OF THE FIGURES

FIG. 1 shows a cross-section SEM picture of a sintered bilayer PTL of example 2 showing a smooth interface between the two layers;

FIG. 2 shows the final sintered bilayer PTL of example 2;

### DETAILED DESCRIPTION OF THE INVENTION

The process according to the invention aims to manufacture a multilayered porous transport layer, also referred to herein as “PTL”. The PTL is capable of transporting and homogeneously distributing reactant, e.g. water, to a catalyst layer and effectively removing oxygen developing at the catalyst/PTL interface without disruption the reactant flow from reaching the catalyst layer.

The feedstock, the metal powder and binder forming the feedstock, and the PTL forming is described below in more detail without restricting the invention thereto.

### Extrusion Feedstock

In a first step of the process according to the invention a first feedstock comprising first metal particles and a first polymer binder a second feedstock comprising second metal particles and a second polymer binder are provided. The first feedstock has metal particles with a smaller average particles size, a higher metal powder content, or both, metal particles with a smaller average particles size and a higher metal powder content, all compared to the second feedstock.

The first and the second feedstock (also together referred to as “extrusion feedstock” or “feedstock”) comprise or consist of two components, a metal powder and a binder as described below in more detail. As used herein the feedstocks refer to solid feedstocks in the form of granulates, pellets or powder. Most preferably granulates.

The feedstock comprises from 40 to 70% by volume of the metal powder as described herein and from 30 to 60% by volume of a binder, based on the total volume of the mixture.

Preferably, the feedstock comprises or essentially consist of from 45 to 65% by volume of the metal powder and from 35 to 55% by volume of the binder, based on the total volume of the feedstock.

Particularly preferably, the feedstock comprises from 48 to 64% by volume of a metal powder and from 36 to 52% by volume of a binder, based on the total volume of the feedstock.

Preferably the feedstock essentially consists of one or more metal powders, one or more binders, and optionally one or more additives, as described below in more detail, where the % by volume of the metal powder, the binder, and the additive add up to 100%.

In a preferred embodiment, the first and the second feedstock have an MFR between 50 to 700 g/10 min, according to ISO 1133 using 190° C. and 21.6 kg. Most preferably, the first and the second feedstock have the same or at least a similar MFR. Similar here means that the MFR difference between the first and the second feedstock is 100 or below, preferably 50 or below, most preferably 10 or below.

Preferably the first feedstock and the second feedstock are free of any solvent. As used herein, “solvent” means a compound or mixture of compounds that are liquid at room temperature, such as but not limited to acetone, n-methyl pyrrolidone, water or formamide.

### Metal Powder

Generally, the metal powder may me made of any metal that can be used as PTL.

Preferably, the metal powder consists of a pulverant metal material comprising or essentially consisting of titanium.

As used herein, “essentially” means that there may be minor amounts of other components, in particular, unavoidable impurities that do not significantly influence the chemical, mechanical, or catalytical properties of the alloy.

In particular, the method according to the invention is provided for a porous transport layer which is formed from titanium or a titanium alloy, but it is however to be understood that porous transport layers of other materials or metal alloys can be formed by the method according to the invention.

Generally, the first and the second feedstocks may comprise from 40 to 70% by volume of the metal powder.

Beneficial for the use in co-extrusion is a spherical powder with an average particle size from 0.1 to 120 μm, preferably from 1 to 100 μm, particularly preferably from 1 to 63 μm, most preferably from 15 to 63 μm measured by laser diffraction. The average particle size (diameter) of the powder is preferably below 100 μm, more preferably below 50 μm, most preferably below 35 μm. Powders may be sieved or classified after atomization to reach the desired particle size distributions. Plasma-treatments of the powders may also be utilized to improve the powder sphericity and to remove contaminants.

There are two approaches to receive different pore sizes and porosities in the first and the second layer of the final PTL.

In a first approach, different average particle sizes may be used in the first and the second feedstock. The higher the average particle size in the feedstock is the higher is the pore size and porosity in the final PTL. Therefore, in a first embodiment of the present invention the first feedstock has metal particles with a smaller average particles size compared to the second feedstock. Preferably, the first feedstock has an average metal powder particle size that is 10-45 μm, more preferably 15-30 μm, which is smaller than the average particle size in the second feedstock.

Preferably the first average particle size may be from 10 to 45 μm, more preferably from 15 to 35 μm, most preferably from 15 to 30 μm.

Preferably the second average particle size may be from 20 to 106 μm, more preferably from 20 to 63 μm, most preferably from 20 to 45 μm.

In a second approach, different amounts of metal powder are used in the first and the second feedstock. In this case the particle size may be the same or different in the first and the second feedstock, preferably the same. The higher the metal particle content in the feedstock is the lower is the pore size and porosity in the final PTL.

Preferably the first feedstock forming the first layer in the final PTL may comprise from 54 to 65% by volume of the metal powder, more preferably from 56 to 65% by volume.

Preferably the second feedstock forming the second layer in the final PTL may comprise from 48 to 56% by volume of the metal powder, more preferably from 48 to 54% by volume.

Besides commercially pure pulverant titanium metal powder, other pulverant metal powders like titanium alloys, stainless steel (SS) metal powders could be utilized to make PTL (anode or cathode side) in the electrolysis as well. For instance, SS grade with high corrosion resistance, high electrical conductivity (e.g. 17-4 PH, 316L, super duplex) are good candidates for the cathodic PTL in PEM electrolysis.

Preferably the metal powder essentially consists of pulverant titanium or stainless steel.

For the preparation of the metal powder, the inorganic material has to be pulverized. To pulverize the inorganic material, any method known to the person skilled in the art may be used. For example, the inorganic material may be ground. The grinding for example may take place in a classifier mill, in a hammer mill or in a ball mill.

Metal powders for use in a co-extrusion process may also be atomized using gas, plasma, or water atomization or hydrogenation. A particular method to produce triangular shaped titanium powder is called hydrogentation dehydrogenation (HDH) as described in Powder Metall. 2016, 59, 249.

In a particular embodiment the first metal particles have a particle size of from

### Binder

According to the present invention, the feedstock comprises from 30 to 60% by volume of the binder. In a preferred embodiment, the mixture comprises from 35 to 55% by volume of the binder and particularly preferably from 36 to 50% by volume of the binder, based on the total volume of the feedstock.

Preferably the binder comprises or essentially consists of (b1) from 40 to 97.5% by weight of at least one polyoxymethylene (POM), (b2) from 2 to 35% by weight of at least one polyolefin (PO), (b3) either no further polymer (FP) or from 0.5 to 20% by weight of at least one further polymer (FP), and (b4) either no dispersant or from 0 to 5% by weight of at least one dispersant, each based on the total weight of the binder, where the % by weight of (b1), (b2), (b3) and (b4) add up to 100%.

In a preferred embodiment, the binder comprises or essentially consists of (b1) from 62 to 94.95% by weight of at least one polyoxymethylene (POM), (b2) from 3 to 20% by weight of at least one polyolefin (PO), (b3) either no further polymer (FP) or from 2 to 15% by weight of at least one further polymer (FP) and (b4) from 0.05 to 3% by weight of at least one dispersant, each based on the total weight of the binder, where the % by weight of components (b1), (b2), (b3), and (b4) usually add up to 100%.

Particularly preferably, the binder comprises or essentially consists of (b1) from 83 to 92.9% by weight of at least one polyoxymethylene (POM), (b2) from 4 to 15% by weight of at least one polyolefin (PO) and (b3) from 3 to 10% by weight of at least one further polymer (FP) and (b4) from 0.1 to 2% by weight of at least one dispersant, each based on the total weight of the binder (B), where the % by weight of components (b1), (b2), (b3) and (b4) add up to 100%.

According to the present invention, the POM differs from the PO, PO differs from the FP, the FP differs from the dispersant and the dispersant differs from the POM. However, POM, PO, FP and the dispersant may comprise identical building units and, for example, differ in a further building unit and/or differ in the molecular weight.

The components (b1) POM, (b2) PE, (b3) FP, and (b4) dispersant of the binder are described in more detail below.

### Polyoxymethylene

According to the present invention, the binder comprises from 40 to 97.5% by weight of Polyoxymethylene (also referred to herein as “POM”). In a preferred embodiment, the binder comprises from 62 to 94.95% by weight of POM and particularly preferably from 83 to 92.9% by weight of POM, based on the total amount of the binder.

At least one POM may be used in the binder. “At least one POM” within the present invention means precisely one POM and also mixtures of two or more POMs.

For the purpose of the present invention, the term “polyoxymethylene” or “POM” encompasses both, POM itself, i. e. polyoxymethylene homopolymers, and polyoxymethylene copolymers and polyoxymethylene terpolymers

POM homopolymers usually are prepared by polymerization of a monomer selected from a formaldehyde source.

The term “formaldehyde source” relates to substances which can liberate formaldehyde under the reaction conditions of the preparation of POM.

The formaldehyde sources are advantageously selected from the group of cyclic or linear formals, in particular from the group consisting of formaldehyde and 1,3,5-trioxane. 1,3,5-trioxane is particularly preferred.

POM copolymers are known per se and are commercially available. They are usually prepared by polymerization of trioxane as main monomer. In addition, comonomers are concomitantly used. The main monomers are preferably selected from among trioxane and other cyclic or linear formals or other formaldehyde sources.

The expression “main monomers” is intended to indicate that the proportion of these monomers in the total amount of monomers, i. e. the sum of main monomers and comonomers, is greater than the proportion of the comonomers in the total amount of monomers.

Quite generally, the POM according to the present invention has at least 50 mol % of repeating units —CH₂O— in the main polymer chain. Suitable polyoxymethylene (POM) copolymers are in particular those which comprise the repeating units —CH₂O— and from 0.01 to 20 mol %, in particular from 0.1 to 10 mol % and very particularly preferably from 0.5 to 6 mol % of repeating units of the formula (I),

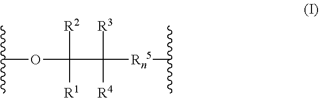

wherein
R¹ to R⁴ are each independently of one another selected from the group consisting of H, C₁ C₄ alkyl and halogen-substituted C₁ C₄ alkyl;
R⁵ is selected from the group consisting of a chemical bond, a (—CR^{5a}R^{5b}—) group and a (—CR^{5a}R^{5b}O—) group,
R^{5a} and R^{5b} are each independently of one another selected from the group consisting of H and unsubstituted or at least monosubstituted C₁ C₄ alkyl, wherein the substituents are selected from the group consisting of F, Cl, Br, OH and C₁ C₄ alkyl; and
n is 0, 1, 2 or 3.

If n is 0, then R⁵ is a chemical bond between the adjacent carbon atom and the oxygen atom. If R⁵ is a (—CR^{5a}R^{5b}O—) group, then the oxygen atom (O) of the (—CR^{5a}R^{5b}O—) group is bound to another carbon atom (C) of formula (I) and not to the oxygen atom (O) of formula (I). In other words, formula (I) does not comprise peroxide compounds. The same holds true for formula (II).

Within the context of the present invention, definitions such as C₁ C₄ alkyl, as for example defined above for the radicals R¹ to R⁴ in formula (I), mean that this substituent (radical) is an alkyl radical with a carbon atom number from 1 to 4. The alkyl radical may be linear or branched and also optionally cyclic. Alkyl radicals which have both a cyclic component and also a linear component likewise fall under this definition. Examples of alkyl radicals are methyl, ethyl, n-propyl, iso-propyl, butyl, iso butyl, sec butyl and tert butyl.

In the context of the present invention, definitions, such as halogen-substituted C₁-C₄-alkyls, as for example defined above for the radicals R¹ to R⁴ in formula (I), mean that the C₁ C₄ alkyl is substituted by at least one halogen. Halogens are F (fluorine), Cl (chlorine), Br (bromine) and I (iodine).

The repeating units of formula (I) can advantageously be introduced into the POM copolymers by ring-opening of cyclic ethers as first comonomers. Preference is given to first comonomers of the general formula (II),

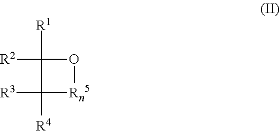

wherein R¹ to R⁵ and n have the meanings as defined above for the general formula (I).

As first comonomers mention may be made for example of ethylene oxide, 1,2-propylene oxide, 1,2-butylene oxide, 1,3-butylene oxide, 1,3-dioxane, 1,3-dioxolane and 1,3-dioxepane as cyclic ethers and also linear oligoformals or polyformals such as polydioxolane or polydioxepane. 1,3 dioxolane and 1,3 dioxepane are particularly preferred first comonomers, very particular preferred is 1,3 dioxolane as first comonomer.

POM polymers which can be obtained by reaction of a formaldehyde source together with the first comonomer and a second comonomer are likewise suitable. The addition of the second comonomer makes it possible to prepare, in particular, POM terpolymers.

The second comonomer is preferably selected from the group consisting of a compound of formula (III) and a compound of formula (IV),

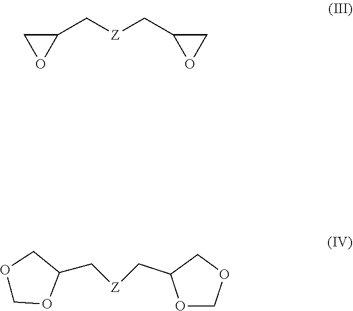

wherein Z is selected from the group consisting of a chemical bond, an (—O—) group and an (—O R⁶ O—) group, wherein R⁶ is selected from the group consisting of unsubstituted C₁ C₈ alkanediyl and C₃ C₈ cycloalkanediyl. The second comonomer may also be used as such as a further additive in the first feedstock, the second feedstock, or both the first and the second feedstock.

The C₁ C₈ alkanediyl is a hydrocarbon having two free valences and a carbon atom number of from 1 to 8. The C₁ C₈ alkanediyl according to the present invention can be branched or unbranched.

A C₃ C₈ cycloalkanediyl is a cyclic hydrocarbon having two free valences and a carbon atom number of from 3 to 8. Hydrocarbons having two free valences, a cyclic and also a linear component, and a carbon atom number of from 3 to 8 likewise fall under this definition.

Preferred examples of the second comonomer (b1c) are ethylene diglycidyl, diglycidyl ether and diethers prepared from glycidyl compounds and formaldehyde, dioxane or trioxane in a molar ratio of 2:1 and likewise diethers prepared from 2 mol of a glycidyl compound and 1 mol of an aliphatic diol having from 2 to 8 carbon atoms, for example the diglycidyl ether of ethylene glycol, 1,4 butanediol, 1,3 butanediol, 1,3 cyclobutanediol, 1,2 propanediol and 1,4 cyclohexanediol.

In a preferred embodiment component (b1) is a polyoxymethylene (POM) copolymer which is prepared by polymerization of from at least 50 mol-% of a formaldehyde source, from 0.01 to 20 mol-% of at least one first comonomer (b1b) and from 0 to 20 mol-% of at least one second comonomer (b1c).

In a particularly preferred embodiment the POM may be a POM copolymer which is prepared by polymerization of from 80 to 99.98 mol-%, preferably from 88 to 99 mol-% of a formaldehyde source, from 0.1 to 10 mol-%, preferably from 0.5 to 6 mol-% of at least one first comonomer and from 0.1 to 10 mol-%, preferably from 0.5 to 6 mol-% of at least one second comonomer.

In a further preferred embodiment the POM may be a POM copolymer which is prepared by polymerization of from at least 50 mol-% of a formaldehyde source, from 0.01 to 20 mol-% of at least one first comonomer of the general formula (II) and from 0 to 20 mol-% of at least one second comonomer selected from the group consisting of a compound of formula (III) and a compound of formula (IV).

In a preferred embodiment of the present invention at least some of the OH-end groups of the POM are capped. Methods for capping OH-end groups are known to the skilled person. For example, the OH-end groups can be capped by etherification or esterification.

Preferred POM copolymers useful for co-extrusion have melting points of at least 150° C., preferably 150 to 200° C., most preferably 160 to 180° C. The melting point of the POM is determined with a heating and cooling rate of 20 K/min according to DIN EN ISO 11357-3 (2013-04) and a sample weight of about 8.5 mg.

Preferred POM copolymers have weight average molecular weights M_{w} in the range from 5 000 g/mol to 300 000 g/mol, preferably from 10 000 to 240 000 g/mol, particularly preferably in the range from 80 000 to 220 000 g/mol.

Preferred POM copolymers have number-average molecular weight M_{w} (determined as described below) is preferably in the range of from 8 000 to 85 000 g/mol, preferably in the range of from 9 000 to 38 000 g/mol.

Preferred POM copolymers useful for co-extrusion have melt-flow-rates (MFR) according to ISO 1133-1 using 190° C. and 2.16 kg of 10 g/10 min or below, preferably from 0.5 to 8 g/10 min, most preferably from 1 to 5 g/10 min.

Particular preference is given to POM copolymers having a polydispersity (Mw/Mn) of from from 1.4 to 14, the Mw/Mn is more preferably in the range of from 2.1 to 14.

The molecular weight of the polymers and the POM was determined via size exclusion chromatography in a SEC apparatus (size exclusion chromatography). This SEC apparatus was composed of the following combination of separating columns: a preliminary column of length 5 cm and diameter 8 mm, a second linear column of length 30 cm and diameter 7.5 mm. The separating material in both columns was PLHFIP gel from Polymer Laboratories. The detector used comprised a differential refractometer from Agilent 1100. A mixture composed of hexafluoro isopropanol with 0.05% of potassium trifluoro acetate was used as eluent. The flow rate was 1 ml/min, the column temperature being 35° C. 60 microliters of a solution at a concentration of 1.5 g of specimen per liter of eluent were injected. This specimen solution had been filtered in advance through Millipor Millex FG (pore width 0.2 micrometers). Narrowly distributed PMMA standards from PSS (Mainz, DE) with molecular weight M from 800 to 2.220.000 g/mol were used for calibration. Polydispersity index is defined as the weight average molecular weight divided by the number average molecular weight.

The measurement of the weight average molecular weight (M_{w}) and the number average molecular weight (Mₙ) is generally carried out by gel permeation chromatography (GPC). GPC is also known as sized exclusion chromatography (SEC).

Methods for the preparation of POM are known to those skilled in the art.

### Polyolefin

The binder usually comprises from 2 to 35% by weight of polyolefin (also referred to herein as “PE”). In a preferred embodiment, the binder comprises from 3 to 20% by weight of the polyolefin and particularly preferably from 4 to 15% by weight of the polyolefin, based on the total amount of the binder.

According to the present invention, the polyolefin is at least one polyolefin. “At least one polyolefin” within the present invention means precisely one polyolefin and also mixtures of two or more polyolefins.

Polyolefins are known per se and are commercially available. They are usually prepared by polymerization of C₂ C₈ alkene monomers, preferably by polymerization of C₂ C₄ alkene monomers.

Within the context of the present invention, C₂ C₈ alkene means unsubstituted or at least monosubstituted hydrocarbons having 2 to 8 carbon atoms and at least one carbon-carbon double bond (C═C double bond). “At least one carbon-carbon double bond” means precisely one carbon-carbon double bond and also two or more carbon-carbon double bonds.

In other words, C₂ C₈ alkene means that the hydrocarbons having 2 to 8 carbon atoms are unsaturated. The hydrocarbons may be branched or unbranched. Examples for C₂ C₈ alkenes with one C═C-double bond are ethene, propene, 1-butene, 2-butene, 2 methyl-propene (=isobutylene), 1-pentene, 2-pentene, 2-methyl-1-butene, 3-methyl-1-butene, 1-hexene, 2-hexene, 3-hexene and 4-methyl-1-pentene. Examples for C₂ C₈ alkenes having two or more C—C-double bonds are allene, 1,3-butadiene, 1,4-pentadiene, 1,3 pentadiene, 2-methyl-1,3-butadiene (=isoprene).

If the C₂ C₈ alkenes have one C═C double bond, the polyolefins prepared from those monomers are linear. If more than one double bond is present in the C₂-C₈ alkenes, the polyolefins prepared from those monomers may be crosslinked. Linear polyolefins are preferred.

It is also possible to use polyolefin copolymers, which are prepared by using different C₂ C₈ alkene monomers during the preparation of the polyolefins.

Preferably, the polyolefins are selected from the group consisting of polymethylpentene, poly-1-butene, polyisobutylene, polyethylene and polypropylene. Particular preference is given to polyethylene and polypropylene and also their copolymers as are known to those skilled in the art and are commercially available.

The polyolefins may be prepared by any polymerization process known to the skilled person, preferably by free radical polymerization, for example by emulsion, bead, solution or bulk polymerization. Possible initiators may be, depending on the monomers and the type of polymerization, free radical initiators such as peroxy compounds and azo compounds with the amounts of initiator generally being in the range from 0.001 to 0.5% by weight, based on the monomers.

### Further Polymer

The binder may further comprise from 1 to 25% by weight of a further polymer. In a preferred embodiment, the binder comprises from 2 to 20% by weight of the further polymer and particularly preferably from 4 to 16% by weight of the further polymer, based on the total amount of the binder.

The further polymer according to the present invention is at least one further polymer. “At least one further polymer” within the present invention means precisely one further polymer and also mixtures of two or more further polymers.

As already stated above, the at least one further polymer differs from the polyoxymethylene, the polyolefin and the dispersant describe below.

According to the present invention, the at least one further polymer is preferably selected from the group consisting of a polyether, a polyurethane, a polyepoxide, a polyamide, a vinyl aromatic polymer, a poly(vinyl ester), a poly(vinyl ether), a poly(alkyl(meth)acrylate) and copolymers thereof.

Preferably, the further polymer is selected from the group consisting of a poly(C₂-C₆ alkylene oxide), an aliphatic polyurethane, an aliphatic uncrosslinked epoxide, an aliphatic polyamide, a vinyl aromatic polymer, a poly(vinyl ester) of an aliphatic C₁-C₈ carboxylic acid, a poly(vinyl ether) of a C₁-C₈ alkyl vinyl ether, a poly(alkyl(meth)acrylate) of a C₁₋₈ alkyl and copolymers thereof.

Preferred further polymers are described in more detail below.

Polyethers comprise repeating units of formula (V).

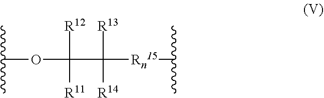

wherein
R¹¹ to R¹⁴ are each independently of one another selected from the group consisting of H, C₁ C₄ alkyl and halogen-substituted C₁ C₄ alkyl;
R¹⁵ is selected from the group consisting of a chemical bond, a (—CR^{15a}R^{15b}—) group and a (—CR^{15a}R^{15b}O—) group,
wherein
R^{15a} and R^{15b} are each independently of one another selected from the group consisting of H and unsubstituted or at least monosubstituted C1 C4 alkyl, wherein the substituents are selected from the group consisting of F, Cl, Br, OH and C₁ C₄ alkyl; and
n is 0, 1, 2 or 3.

If n is 0, then R¹⁵ is a chemical bond between the adjacent carbon atom and the oxygen atom. If R¹⁵ is a (—CR^{15a}R^{15b}O—) group, then the oxygen atom (O) of the (—CR^{15a}R^{15b}O—) group is bound to another carbon atom (C) of formula (V) and not to the oxygen atom (O) of formula (V). In other words, formula (V) does not comprise peroxide compounds. The same holds true for formula (VI).

Typical polyethers as well as their preparation are known to the skilled person.

A preferred polyether according to the present invention is, for example, a poly(alkylene glycol), also known as a poly(alkylene oxide).

Polyalkylene oxides and their preparation are known to the skilled person. They are usually synthesized by interaction of water and a bi- or polyvalent alcohol with cyclic ethers, i. e. alkylene oxides, of the general formula (VI). The reaction is catalyzed by an acidic or basic catalyst. The reaction is a so called ring-opening polymerization of the cyclic ether of the general formula (VI).

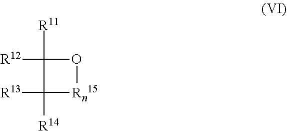

wherein
R¹¹ to R¹⁵ have the same meanings as defined above for formula (V).

A preferred poly(alkylene oxide) according to the present invention is derived from monomers of the general formula (VI) having 2 to 6 carbon atoms in the ring. In other words, preferably, the poly(alkylene oxide) is a poly(C₂-C₆ alkylene oxide). Particular preference is given to a poly(alkylene oxide) derived from monomers selected from the group consisting of 1,3 dioxolane, 1,3 dioxepane and tetrahydrofuran (IUPAC-name: oxolane). In other words, particularly preferably, the poly(alkylene oxide) is selected from the group consisting of poly-1,3 dioxolane, poly-1,3 dioxepane and polytetrahydrofuran.

In one embodiment, the poly(alkylene oxide) can comprise OH-end groups. In another embodiment, at least some of the OH-end groups of the poly(alkylene oxide) can be capped. Methods for capping OH-end groups are known to the skilled person. For example, the OH-end groups can be capped by etherification or esterification.

The weight average molecular weight of the poly(alkylene oxide) is preferably in the range of from 1 000 to 100 000 g/mol, particular preferably from 1 200 to 80 000 g/mol and more preferably in the range of from 1 500 to 50 000 g/mol.

A polyurethane is a polymer having carbamate units. Polyurethanes as well as their preparation is known to the skilled person.

Within the present invention, aliphatic polyurethanes are preferred. They can, for example, be prepared by polyaddition of aliphatic polyisocyanates and aliphatic polyhydroxy compounds. Among the polyisocyanates, diisocyanates of the general formula (VII) are preferred

OCN—R⁷—NCO (VII),
wherein
R⁷ is a substituted or unsubstituted C₁-C₂₀ alkanediyl or C₄-C₂₀ cycloalkanediyl, wherein the substituents are selected from the group consisting of F, Cl, Br and C₁ C₆ alkyl.

Preferably R⁷ is a substituted or unsubstituted C₂ C₁₂ alkandiyl or C₆ C₁₅ cycloalkanediyl.

The C₁ C₂₀ alkanediyl is a hydrocarbon having two free valences and a carbon atom number of from 1 to 20. The C₁ C₂₀ alkyanediyl according to the present invention can be branched or unbranched.

Within the context of the present invention, definitions such as C₄-C₂₀ cycloalkanediyl means C₄ C₂₀ cycloalkanediyle. A C₄ C₂₀ cycloalkanediyl is a cyclic hydrocarbon having two free valences and a carbon atom number of from 4 to 20. Hydrocarbons having two free valences, a cyclic and also a linear component and a carbon atom number of from 4 to 20 likewise fall under this definition.

Preferred diisocyanates are selected from the group consisting of hexamethylene diisocyanate, 2,2,4 trimethyl hexamethylene diisocyanate, 2,4,4 trimethyl hexamethylene diisocyanate, 1,2-diisocyanatomethyl cyclohexane, 1,4 diisocyanatomethyl cyclohexane and isophoron diisocyanate (IUPAC-name: 5-iso-cyanato 1 (isocyanatomethyl) 1,3,3 trimethyl-cyclohexane).

The diisocyanates may also be used in oligomeric, for example dimeric or trimeric form. Instead of the polyisocyanates, it is also possible to use conventional blocked polyisocyanates which are obtained from the stated isocyanates, for example by an addition reaction of phenol or caprolactam.

Suitable polyhydroxy compounds for the preparation of aliphatic polyurethanes are, for example, polyesters, polyethers, polyesteramides or polyacetales or mixtures thereof.

Suitable chain extenders for the preparation of the polyurethanes are low molecular weight polyols, in particular diols and polyamines, in particular diamines or water.

The polyurethanes are preferably thermoplastic and therefore preferably essentially uncrosslinked, i. e. they can be melted repeatedly without significant signs of decomposition. Their reduced specific viscosities are as a rule from 0.5 to 3 dl/g, preferably from 1 to 2 dl/g measured at 30° C. in dimethylformamide.

A polyepoxide comprises at least two epoxide groups. The epoxide groups are also known as glycidyl or oxirane groups. “At least two epoxide groups” mean precisely two epoxide groups and also three or more epoxide groups.

Polyepoxides and their preparation is known to the person skilled in the art. For example, polyepoxides are prepared by the reaction of epichlorhydrine (IUPAC-name: chlormethyloxirane) and a diol, a polyol or a dicarboxylic acid. Polyepoxides prepared in this way are polyethers having epoxide end groups.

Another possibility to prepare polyepoxides is the reaction of glycidyl(meth)acrylate (IUPAC-name: oxiran-2-ylmethyl-2-methylprop-2-enoate) with polyolefins or polyacrylates. This results in polyolefins or polyacrylates having epoxy end groups.

Preferably, aliphatic uncrosslinked polyepoxides are used. Copolymers of epichlorhydrine and 2,2 bis (4-hydroxyphenyl)-propane (bisphenol A) are particularly preferred. 40 Component (b3) (the at least one further polymer (FP)) can also comprise a polyamide.

Aliphatic polyamides are preferred.

The intrinsic viscosity of suitable polyamides is generally from 150 to 350 ml/g, preferably from 180 to 275 ml/g. Intrinsic viscosity is determined here from a 0.5% by weight solution of the polyamide in 96% by weight sulfuric acid at 25° C. in accordance with ISO 307.

Preferred polyamides are semicrystalline or amorphous polyamides.

Examples of polyamides suitable as component (b3) are those that derive from lactams having from 7 to 13 ring members. Other suitable polyamides are those obtained through reaction of dicarboxylic acids with diamines.

Examples that may be mentioned of polyamides that derive from lactams are polyamides that derive from polycaprolactam, from polycaprylolactam, and/or from polylaurolactam.

If polyamides are used that are obtainable from dicarboxylic acids and diamines, dicarboxylic acids that can be used are alkanedicarboxylic acids having from 6 to 14 carbon atoms, preferably from 6 to 10 carbon atoms. Aromatic dicarboxylic acids are also suitable.

Examples that may be mentioned here as dicarboxylic acids are adipic acid, azelaic acid, sebacic acid, dodecanedicarboxylic acid, and also terephthalic acid and/or isophthalic acid.

Examples of suitable diamines are alkanediamines, having from 4 to 14 carbon atoms, in particular alkanediamines having from 6 to 8 carbon atoms, and also aromatic diamines, for example m-xylylenediamine, di(4-aminophenyl)methane, di(4-aminocyclohexyl)methane, 2,2-di(4-aminophenyl)propane, 2,2-di(4-aminocyclohexyl)-propane, and 1,5-diamino-2-methylpentane.

Other suitable polyamides are those obtainable through copolymerization of two or more of the monomers mentioned above and mentioned below, and mixtures of a plurality of polyamides in any desired mixing ratio.

Preferred polyamides are polyhexamethyleneadipamide, polyhexamethylene-sebacamide, and polycaprolactam, and also nylon 6/6,6, in particular having a proportion of from 75 to 95% by weight of caprolactam units.

Particular preference is given to mixtures of nylon 6 with other polyamides, in particular with nylon 6/6,6 (PA 6/66), particular preference being given to mixtures of from 80 to 50% by weight of PA 6 and from 20 to 50% by weight of PA 6/66, where the PA 6/66 comprises from 75 to 95% by weight of caprolactam units, based on the total weight of the PA 6/66 in the mixture.

The following, non-exclusive list comprises the abovementioned polyamides, and other suitable polyamides, and also the monomers comprised.

### AB Polymers:

PA 4 Pyrrolidone
PA 6 ε-Caprolactam
PA 7 Ethanolactam
PA 8 Caprylolactam
PA 9 9-Aminopelargonic acid
PA 11 11-Aminoundecanoic acid
PA 12 Laurolactam

### AA/BB Polymers:

PA 46 Tetramethylenediamine, adipic acid
PA 66 Hexamethylenediamine, adipic acid
PA 69 Hexamethlyenediamine, azelaic acid
PA 610 Hexamethylenediamine, sebacic acid
PA 612 Hexamethylenediamine, decanedicarboxylic acid
PA 613 Hexamethylenediamine, undecanedicarboxylic acid
PA 1212 1,12-Dodecanediamine, decanedicarboxylic acid
PA 1313 1,13-Diaminotridecane, undecanedicarboxylic acid
PA 6T Hexamethylenediamine, terephthalic acid
PA MXD6 m-Xylylenediamine, adipic acid
PA 6I Hexamethylenediamine, isophthalic acid
PA 6-3-T Trimethylhexamethylenediamine, terephthalic acid
PA 6/6T (see PA 6 and PA 6T)
PA 6/66 (see PA 6 and PA 66)
PA 6/12 (see PA 6 and PA 12)
PA 66/6/610 (see PA 66, PA 6 and PA 610)
PA 6I/6T (see PA 6I and PA 6T)
PA PACM 6 Diaminodicyclohexylmethane, adipic acid
PA PACM 12 Diaminodicyclohexylmethane, laurolactam
PA 6I/6T/PACM as PA 6I/6T+diaminodicyclohexylmethane
PA 12/MACMI Laurolactam, dimethyldiaminodicyclohexylmethane, isophthalic acid
PA 12/MACMT Laurolactam, dimethyldiaminodicyclohexylmethane, terephthalic acid
PA PDA-T Phenylenediamine, terephthalic acid

Preferred polyamides are PA 6, PA 66 and PA PACM 6.

Vinyl aromatic polymers are polyolefins having unsubstituted or at least monosubstituted styrene as monomer unit. Suitable substituents are, for example, C1 C6 alkyls, F, Cl, Br and OH. Preferred vinyl aromatic polymers are selected from the group consisting of polystyrene, poly-α methylstyrene and copolymers thereof with up to 30% by weight of comonomers selected from the group consisting of acrylic esters, acrylonitrile and methacrylonitrile.

Vinyl aromatic polymers are commercially available and known to the person skilled in the art. The preparation of these polymers is also known to the person skilled in the art.

Preferably, the vinyl aromatic polymers are prepared by free radical polymerization, for example by emulsion, bead, solution or bulk polymerization. Possible initiators are, depending on the monomers and the type of polymerization, free radical initiators such as peroxide compounds and azo compounds with the amounts of initiator generally being in the range from 0.001 to 0.5% by weight, based on the monomers.

Poly(vinyl esters) and their preparation are known to the skilled person. Poly(vinyl esters) are preferably prepared by polymerization of vinyl esters. In a preferred embodiment of the present invention, the vinyl esters are vinyl esters of aliphatic C1 C6 carboxylic acids. Preferred monomers are vinyl acetate and vinyl propionate. These monomers form poly(vinyl acetate) and poly(vinyl propionate) polymers.

Poly(vinyl ethers) are prepared by polymerization of vinyl ether monomers. Poly(vinyl ethers) and their preparation are known to the skilled person. In a preferred embodiment, the vinyl ethers are vinyl ethers of aliphatic C1 C8 alkyl ethers. Preferred monomers are methyl vinyl ether and ethyl vinyl ether, forming poly(methyl vinyl ether) and poly(ethyl vinyl ether) during the polymerization.

Preferably, the poly(vinyl ethers) are prepared by free radical polymerization, for example by emulsion, bead, solution, suspension or bulk polymerization. Possible initiators are, depending on the monomers and the type of polymerization, free radical initiators such as peroxide compounds and azo compounds with the amounts of initiator generally being in the range from 0.001 to 0.5% by weight, based on the monomers.

Poly(alkyl(meth)acrylate) within the present invention comprises poly(alkyl acrylate), poly(alkyl methacrylates) and copolymers thereof. Poly(alkyl(meth)acrylate) comprises units derived from monomers of formula (VIII),

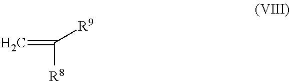

wherein
R⁸ is selected from the group consisting of H and C1 C8 alkyl and
R⁹ is a radical of formula (IX)

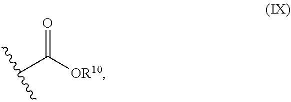

wherein R¹⁰ is a C¹ C¹⁴ alkyl.

Preferably, R⁸ is selected from the group consisting of H and C₁-C₄-alkyl, particularly preferably R⁸ is H or methyl. Preferably, R¹⁰ is a C₁-C₈-alkyl, particularly preferably, R10 is methyl or ethyl.

If R⁸ in formula (VIII) is H and R⁹ is a radical of formula (IX) and R¹⁰ in formula (IX) is methyl, then the monomer of formula (VIII) is methyl acrylate.

If R⁸ in formula (VIII) is H and R⁹ is a radical of formula (IX) and R¹⁰ in formula (IX) is ethyl, the monomer of formula (VIII) is ethyl acrylate.

If R⁸ in formula (VIII) is methyl and R⁹ is a radical of formula (IX), then the monomers of formula (VI) are methacrylic esters.

Poly(alkyl(meth)acrylates) comprise as monomers preferably 40 to 100% by weight of methacrylic esters, particularly preferably 70 to 100% by weight of methacrylic esters and more preferably from 80 to 100% by weight of methacrylic esters, each based on the total amount of the poly(alkyl(meth)acrylates).

In another preferred embodiment, the poly(alkyl(meth)acrylates) comprise as monomers from 20 to 100% by weight of methyl acrylate, ethyl acrylate or a mixture thereof, preferably from 40 to 100% by weight of methyl acrylate, ethyl acrylate or a mixture thereof and particularly preferably from 50 to 100% by weight of methyl acrylate, ethyl acrylate or mixtures of thereof, each based on the total weight of the poly(alkyl(meth)acrylate).

The person skilled in the art knows that the monomers described above for the preparation of the components (b1), (b2) and (b3) can undergo changes in their structure during the polymerization reaction. Consequently, the building units of the polymers are not the same as the monomers from which they are derived. However, the person skilled in the art knows which monomers correspond to which building unit of the polymers.

Under the conditions of compounding or processing by injection molding, virtually no transacetalization occurs between component (b1), the polyoxymethylene (POM), and component (b3), the at least one further polymer (FP), i. e. virtually no exchange of comonomer units takes place.

In another embodiment of the present invention that is a particular useful for fused filament fabrication processes the at least one further polymer (FP) is selected from the group consisting of a polyether, a polyurethane, a polyepoxide, a polyamide, a vinyl aromatic polymer, a poly(vinyl ester), a poly(vinyl ether), a poly(alkyl (meth)acrylate) and copolymers thereof.

### Additives

In one embodiment of the present invention, the feedstock may comprise from 0 to 5% by volume of a dispersant. In a preferred embodiment, the mixture comprises from 0.05 to 3% by volume of the dispersant and particularly preferably from 0.1 to 3% by volume of the dispersant, each based on the total volume of the mixture.

As the dispersant one or more dispersants may be used.

Useful dispersants are generally known in the art. Examples are oligomeric polyethylene oxide having a low molecular weight of from 200 to 600 g/mol stearic acid, stearamides, hydroxystearic acids, fatty alcohols, fatty alcohol sulfonates and block copolymers of ethylene oxide and propylene oxide and also, particularly preferably, fatty acid esters.

In one embodiment of the invention, the feedstock may comprise other additives like polysorbate.

### PTL-Forming

According to the invention, a PTL is formed by carrying out the following the steps.

In a first step a first feedstock comprising first metal particles and a first polymer binder and a second feedstock comprising second metal particles and a second polymer binder is provided. Herein, the first and the second feedstock has a metal powder content of 40 to 70% by volume and the first feedstock have either metal particles of a smaller average particle size or a higher metal powder content, or both, metal particles with a smaller average particles size and a higher metal powder content compared to the particles in the second feedstock.

In a second step the first and the second feedstock are coextruded to form a film-shaped green body comprising a first layer and a second layer. In this coextrusion step the second layer is materially connected to the first layer at temperatures above the melting temperature and or glass transition temperature of said first and second binder.

The second step may be followed by an optional step to further post-treat the film-shaped green body by rolling or calendering.

Finally, the film-shaped green body is debinded, preferably catalytically debinded, to form a brown body, followed by sintering the brown body under a non-oxidative atmosphere or in vacuum, preferably below 104 mbar, and a temperature of from 700 to 1300° C. to form the porous transport layer.

One embodiment is process for manufacturing a multilayered porous transport layer, the process comprising
(a) providing a first feedstock comprising first metal particles and a first polymer binder; and providing a second feedstock comprising second metal particles and a second polymer binder;
   the first and the second feedstock having a metal powder content of 40 to 70% by volume; and
   the first feedstock having
   (i) metal particles with a smaller average particles size,
   (ii) a higher metal powder content, or
   (iii) both, metal particles with a smaller average particles size and a higher metal powder content
   compared to the second feedstock;
(b) coextruding the first and the second feedstock to form a film-shaped green body comprising a first layer and a second layer, the second layer being materially connected to the first layer at temperatures above the melting temperature and or glass transition temperature of the first polymer binder and the second polymer binder;
(c) optionally smoothing the film-shaped green body by rolling or calendering;
(d) debinding the film-shaped green body to form a brown body;
(e) sintering the brown body under a non-oxidative atmosphere or vacuum and a temperature of from 700 to 1100° C. to form the porous transport layer

A particularly preferred embodiment is a process for manufacturing a multilayered porous transport layer, the process comprising
(a) providing a first feedstock comprising first metal particles and a first polymer binder; and providing a second feedstock comprising second metal particles and a second polymer binder;
   the first and the second feedstock having a metal powder content of 40 to 70% by volume; and
   the first feedstock having
   (i) metal particles with a smaller average particles size,
   (ii) a higher metal powder content, or
   (iii) both, metal particles with a smaller average particles size and a higher metal powder content
   compared to the second feedstock;
(b) coextruding the first and the second feedstock to form a film-shaped green body comprising a first layer and a second layer, the second layer being materially connected to the first layer at temperatures above the melting temperature and or glass transition temperature of said first polymer binder and second polymer binder;
(c) optionally smoothing of the film-shaped green body by rolling or calendering;
(d) debinding the film-shaped green body to form a brown body;
(e) sintering the brown body under a non-oxidative atmosphere or vacuum and a temperature of from 700 to 1100° C. to form the porous transport layer;
wherein the the first feedstock and the second feedstock are free of any solvents the first feedstock and the second feedstocks have a melt flow rate between 50 to 700 g/10 min, according to ISO 1133 at 190° C. and 21.6 kg; and the first polymer binder, the second polymer binder, or both the first and the second polymer binder have a melt flow rate according to ISO 1133-1 at 190° C. and 2.16 kg of 1 to 5 g/10 min; and
the first polymer binder, the second polymer binder, or both the first and the second polymer binder comprise
(i) 35 to 55% by volume of a polyoxymethylene;
(ii) 2 to 10% by volume of a polyolefin;
(iii) optionally 3 to 10% by volume of a further polymer; and
(iv) optionally 0.5 to 5% by volume of a dispersant.

### Feedstock Preparation

The feedstocks in step (a) may be prepared by any method known to the skilled person. Preferably the feedstock is produced by melting the binder and mixing in the metal powder. For example, the binder may be melted in a twin-screw extruder at temperatures of preferably from 150 to 220° C., in particular of from 170 to 200° C. The metal powder is subsequently metered in the required amount into the melt stream of the binder at temperatures in the same range. Alternatively, the binder may be melted in a sigma-kneader extruder at temperatures of preferably from 150 to 220° C., in particular of from 170 to 200° C. The metal powder is subsequently metered in the required amount into the melt stream of the binder at temperatures in the same range.

Preferably the first feedstock and the second feedstock are free of any solvents.

Furthermore, the whole compounding line, i.e. hoppers, dosing units, twin screw extruders, granulator, etc could preferably be set up as a closed systems, which can be flushed with inert cases to improves the safety handling of the pulverant Titanium, or pulverant metal powder in general.

The distributive and dispersive mixing of the metal powder inside the binder matrix, which dictates the pore size distribution, may be influenced by adapting the screw design, which can be designed by ways known to the skilled person.

During compounding, the binder is melted, and further mixing/homogenization is carried out. The distributive and dispersive mixing can be adjusted based on the process design. Custom screw design could be carried out by ways known to the skilled person. Melt strands are extruded through die head, where it gets granulated and further cooled down.

Any compounding method can be used to melt and further homogenize the feedstock, such as but not limited to kneaders, planetary extruders, twin screw extruders, etc, may be used.

In a preferred embodiment, twin screw extruders are used as the main compounding method, through which narrow mono or bimodal pore size distribution is obtained. In this way the oxygen transport properties of the PTL are improved and the pressure-drop is reduced to improve the water transport through the PTL.

### Co-Extrusion

According to the invention, the first and the second feedstock are coextruded in step (b) to form a film-shaped green body comprising a first layer and a second layer, the second layer being materially connected to the first layer at temperatures above the melting temperature and or glass transition temperature of the first polymer binder and the second polymer binder.

The coextrusion leads to a simplified processing and allows the formation of two or more layered PTLs in a one step process. The coextrusions leads to a gradient of porosity and pore size distribution within the bilayer or multilayer PTL, i.e. a continuous and smooth transition from the smaller porosity and pore size of the first layer to the higher porosity and pore size of the second layer without any discontinuities or creation of highly porous areas in the transition phase of the PTL. It further leads to reduced internal stress at the interface between the first, the second layer and optionally further layers. All this results in better oxygen-water transport behavior, better mechanical properties and less defects in the end sintered PTL, such as but not limited to inner cracks, bumps or warpage of the surface.

The coextrusion is typically performed by using conventional cast film (co-)extrusion machines known in the art with respective single or double screw extruders for feeding the respective feedstocks. In one embodiment, the melt is extruded through a flat die with a gap in the range of 0.1 to 2 mm with multiple adjustable heating zone. The extruded melt are fed into with a roller system to further reduce shape and cool the melt and finally reduce the thickness to the targeted final thickness of the film-shaped green body.

Optionally a third, fourth, or even more layers may be coextruded to receive a green body and afterwards a PTL comprising three, four, or even more layers. The additional layer(s) may be coextruded on the first or the second layer. The layers should be organized in the order, where the layer with the highest porosity and average pore size is in contact with the bipolar plates, flowed by a layer with lower porosity and lower average pore size, finally leading to the layer with the lowest porosity and average pore size, which is brought to contact with the catalyst layer.

For some POM grades, it may be useful to ensure that the max. permissible water content in the binder is less than 0.2 wt %, based on the total binder. If necessary, pre-drying may be used to reduce the water content to below 0.2 wt %. By way of example, pre-drying may be performed at a temperature of about 100° C. for about 3 h.

For coextrusion, a melt temperature of 175° C. to 220° C. is preferably used. Through this process, a three-dimensional green body is produced.

The feedstock may be processed particularly advantageously with three-zone screws with an overall length L of 20-25 D and a constant flight pitch of approx. 1 D. However, short compression screws may also be used.

Due to the temporal and local differences in solidification and cooling of the melt, stresses may occur, especially with lower layer thicknesses. These stresses may be relieved by subsequent heat treatment. Where high dimensional stability is required, a tempering step may be required. Tempering may be performed in air, liquid wax or oil at temperatures of 100 to 150° C., preferably 110 to 130° C. Usually, 10 minutes per 1 mm wall thickness of tempering time are required. This step could be performed separately or simultaneously with the debinding in debinding ovens.

In order to minimise the use of material, reduce through-plane resistivity and to keep the thickness of the porous transport layer as small as possible, it is advantageous to design the film which is shaped out from metal powder and binder in a thickness of 0.1 mm to 1 mm, preferably in a thickness of 0.1 mm to 0.5 mm. Herein, the minimal layer thickness is determined by the maximal grain size or the sieve size of the metal powder fraction—the smaller the maximal grain size, the smaller can the layer thickness of the film also be.

For example, given a PEM electrolyser, the micro-porous layer is envisaged to be brought to bear on a catalyst layer which is arranged on a polymer electrolyte membrane. In order to here ensure a well conductive surfaced contact, according to a further development of the method according to the invention one envisages smoothing the surface of the porous transport layer at its side which is envisaged for being brought to bear on a catalyst, thus the free surface of the microscopic layer, by way of rolling or calendering film-shaped green body.

In a preferred embodiment the thickness of the film-shaped green body is between 0.1 to 1 mm, preferably between 0.1 to 0.5 mm.

In one embodiment of the invention, meters-long of the film-shaped green body is preferably rolled onto a spool for ease of handling and storage and transfer.

### Debinding

The coextrusion step is followed by a debinding step in which at least part of the binder is removed from the three-dimensional green body. The binder is removed thermally or catalytically. Catalytical debinding is preferred.

To remove at least part of the binder, the three-dimensional green body is preferably treated with a gaseous acid comprising atmosphere. Appropriate processes are described, for example, in US 2009/0288739 and U.S. Pat. No. 5,145,900. This process step is, according to the invention, preferably carried out at temperatures below the melting temperature of the binder. In general, the debinding is carried out at a temperature in the range of from 20 to 150° C. and particularly preferably of from 100 to 140° C. Preferably, the debinding step is carried out for a period of from 0.1 to 24 h, particularly preferably of from 0.5 to 12 h and most preferably from 0.5 to 4 h.

The treatment time required depends on the treatment temperature and the concentration of the acid in the treatment atmosphere and also on the size and thickness of the three-dimensional object.

Catalytic debinding gives the needed tempering effect of co-extruded green bodies to further flatten the large green PTL by means of temperature and gravity. This is especially important for film-shaped green body with thicknesses below 1 mm. Furthermore, this step helps flattening the previously rolled film-shaped green body on spool, e.g. during transportation, storage, etc.

Catalytic debinding uniquely offers the possibility of slowing down the debinding reaction speed which is preferable to mitigate unavoidable internal stresses within the PTL resulting from; thin flat sheet co-extrusion that involves highly filled polymer melt bypassing a thin flat die with a gap of 0.1 mm to 2 mm followed by a system of rollers to adjust the final film thickness and/or subsequent calendering. In addition to stresses due to different thermal properties of the different feedstock mixtures utilized.

Suitable acids for the debinding are, for example, inorganic acids which are either gaseous at room temperature or can be vaporized at the treatment temperature or below. Examples are hydrogen halides and nitric acid. Hydrogen halides are hydrogen fluoride, hydrogen chloride, hydrogen bromide and hydrogen iodide. Suitable organic acids are those, which have a boiling point at atmosphere pressure of less than 130° C., e. g. formic acid, acetic acid or trifluoroacetic acid and mixtures thereof. Acids with boiling points above 130° C., for example methanesulfonic acid, can also be utilized in the debinding step when dosed as a mixture with a lower boiling acid and/or water. Preferred acids for process step (Ill) are nitric acid, a 10% by weight solution of oxalic acid in water or a mixture of 50% by volume of methanesulforic acid in water.

Furthermore, BF₃ and its adducts with inorganic ethers can be used as acids.

If a carrier gas is used, the carrier gas is generally passed through the acid and loaded with the acid beforehand. The carrier gas, which has been loaded in this way with the acid, is then brought to the temperature at which the debinding is carried out. This temperature is advantageously higher than the loading temperature in order to avoid condensation of the acids. Preferably the temperature at which debinding is carried out is at least 1° C., particularly preferably at least 5° C. and most preferably at least 10° C. higher than the loading temperature.

Preference is given to mixing the acid into the carrier gas by means of a metering device and heating the gas mixture to such a temperature that the acid can no longer condense. Preferably the temperature is at least 1° C., particularly preferably at least 5° C. and most preferably at least 10° C. higher than the sublimation and/or vaporization temperature of the acid and/or the carrier gas.

The carrier gas in general is any gas that is inert under the reaction conditions of the catalytic debinding step. A preferred carrier gas according to the present invention is nitrogen or Argon, most preferably nitrogen. The binder removal may also be carried out under reduced pressure.

The catalytic debinding is preferably continued until the polyoxymethylene (POM) of the binder has been removed to an extent of at least 80% by weight, preferably at least 90% by weight, particularly preferably at least 95% by weight, based on the total weight of the POM. This may be checked, for example, with the height of the weight decrease.

It is known to the skilled person that at the temperatures of the catalytic debinding step, the metal powder comprised in the three-dimensional green body may undergo chemical and/or physical reactions. In particular, the particles of the metal powder may fuse together, undergo solid state phase transitions and/or chemical reactions with the acidic atmosphere or carrier gas.

The same holds true for the binder. During the catalytic debinding step the composition of the binder may change.

### Sintering

The debinding of the green body is followed by a sintering step (f) in which the three-dimensional brown body is sintered.

After the sintering, the three-dimensional object is a three-dimensional sintered body.

The three-dimensional sintered body comprises the consolidated form of the initial metal powder and is essentially free of the binder.

“Essentially free of the binder” according to the present invention means that the three-dimensional sintered body comprises less than 5% by volume, preferably less than 2% by volume, particularly preferably less than 0.5% by volume and most preferably less than 0.01% by volume of the binder.

It is known to the skilled person that during the sintering process the metal powder is sintered together to give a sintered inorganic powder. Furthermore, during the sintering process the metal powder can undergo chemical and/or physical reactions. Consequently, the metal powder comprised in the three-dimensional brown body usually differs from the sintered inorganic powder comprised in the three-dimensional sintered body.

The sintering may generally be performed by heating the brown body to a temperature of from 700 to 1300° C. for a time sufficient to sinter the particles.

In a preferred embodiment for pure titanium particles sinter temperatures of from 700 to 1100° C., preferably from 800 to 980° C., most preferably from 850 to 950° C. are used. For instance, by sintering PTLs at 870° C. instead of 940° C. at the same sinter hold time, the porosity could be increased by ca. 15%. Furthermore, the average pore size diameter could be increased by 2-4 μm. The whole PTL (2 or 3-layered PTL) is sintered at the same temperature and for the same time.

In one embodiment of the present invention, the sintering is performed by the following temperature profile:
i. heating to a temperature of from 550 to 650° C. at a rate of from 2 to 7° C./min,
ii. holding at the temperature from 550 to 650° C. for 0.5 to 1.5 h,
iii. heating to a temperature of from 700 to 1000° C. at a rate of 2 to 7° C./min,
iv. holding at the temperature of from 700 to 1000° C. for 0.5 h to 2 h, and
v. cooling down to ambient temperature at a rate of from 5 to 15° C./min.

In another embodiment of the present invention, the sintering may be performed by the following temperature profile:
i. heating to a temperature of from 550 to 650° C. at a rate of from 2 to 7° C./min,
ii. holding at the temperature from 550 to 650° C. for 0.5 to 1.5 h,
iii. heating to a temperature of from 650-800° C. at a rate of from 2 to 7° C./min,
iv. heating to a temperature of from 800 to 1100° C. at a rate of 2 to 7° C./min,
v. holding at the temperature of from 800 to 1100° C. for 2 h to 5 h, and
vi. cooling down to ambient temperature at a rate of from 5 to 15° C./min.

The sintering step is preferably performed by using an atmosphere of argon, nitrogen, hydrogen, partial pressure variants or a mixture of thereof at atmospheric pressures. The use of reduced pressures or vacuum is also possible. When sintering Titanium powder in Vacuum pressures below 104 mbar are preferred.

In one embodiment of the present invention, after the debinding and before the sintering, the three-dimensional brown body obtained in process step (e) may be heated for preferably 0.1 to 12 h, particularly preferably from 0.3 to 6 h, at a temperature of preferably from 250 to 700° C., particularly preferably from 250 to 600° C. to remove the residual binder completely.

Alternatively or additionally, to the smoothing, it may be advantageous to chemically roughen this surface, preferably by way of etching. In particular, the porosity in the surface region as well as an intimate, electrically conductive contact when the surface is brought to bear on a catalyst layer is ensured by way of this. Given a porous transport layer which is formed from titanium, such a pickling procedure can be affected for example by way of treatment with sulphuric acid.

Alternatively or additionally, the final PTL may be surface treated in a post treatment by e.g. hydrochloric acid as described in Journal of Applied Electrochemistry (2018) 48:713-723. In this case HCl can reduce the TiO₂ content, which is return improve the electrical conductivity of the PTL. This reflects positively on the PTL efficiency and durability.

### PTL

The process according to the invention provides a PTL comprising at least two layers of different porosity without any discontinuity, particularly without any highly porous band in the transition phase between the two layers of the PTL. The method according to the invention may be used to manufacture a porous transport layer for an electrochemical cell, for example for a battery, for a fuel cell or for an electrolyser.

The porosity of the layer(s) in the final PTL may be varied by changing the metal powder loading degree (formulation) and/or sintering temperatures. In general, higher sinter temperatures, reduce the porosity and average pore size diameter, as the Embodiment sinters to higher densities. The porosity can be measured by volume intrusion mercury porosimetry, pressure difference methods, fluid saturation, or optical methods. Preferably, the porosity is measured by volume intrusion mercury porosimetry in accordance with DIN 66133.

As already described above, the pore sizes are mainly controlled through changing the grain size of the powder and/or the binder/powder ratio.

Pore size and pore size distribution can be measured using mercury volume intrusion porosimetry according to DIN 66133 or by bubble point measurements according to ISO 4003 and ASTM E 1294, respectively, preferably by Capillary flow porometry technique to determine the pore diameter of through pores and their size distribution of the PTL in accordance with the ASTM standard F316.

In one embodiment the (first) mesoporous layer has a smaller pore size of from about 5 μm to about 14 μm at the side of the catalyst layer; and the (second) metal porous layer (substrate) at the side of the bipolar plates having pore sizes of from about 15 μm to about 40 μm.

In a preferred embodiment the PTL shows overall porosities between 30 to 65 vol %. Preferably, specific porosities of 30 to 50 vol % in the first layer and of 40 to 65 vol % in the second layer are achieved.

In another preferred embodiment the PTL shows overall pore sizes of 5 to 40 μm. Preferably, specific first layer 5-14 μm, second layer 14-40 μm)

By coextruding bilayer or multilayer films according to the invention PTLs may be produced which show
a gradient in porosity across the interface between the at least two coextruded layers.
a gradient in average pore size diameter across the interface between the at least two coextruded layers, and
bimodal distribution with two sharp peaks.

The main befits of the PTLs manufacture according to the invention are:
Overall better water (reactant) transport
Better oxygen transport
Better interfacial contact to catalyst, thus better catalyst utilization
Better Mechanical properties
Higher efficiency
Lower total capital expenditures due to lower catalyst loading

All percent, ppm or comparable values refer to the weight with respect to the total weight of the respective composition except where otherwise indicated. All cited documents are incorporated herein by reference.

The following examples shall further illustrate the present invention without restricting the scope of this invention.

### EXAMPLES

The melt flow rate (MFR) was measured according to ISO 1133-1 using 190° C. and 2.16 kg (for the binder) or 21.6 kg (for the feedstock).

The particles sizes of the metal powder were determined by static light scattering measurements performed on a Beckman Coulter LS 13320.

The porosity was measured by volume intrusion mercury porosimetry in accordance with DIN 66133.

The pore size diameter and pore size distribution were measured using mercury volume intrusion porosimetry in accordance to DIN 66133.

### Example 1

A spherical Ti-metal powder with a powder grain size of D50=33 μm was procured.

This powder was converted into feedstocks by mixing/compounding them with liquid additive and binder using a co-rotating twin-screw extruder. The compositions of the first and second feedstocks are shown in tables 1 and 2, respectively.

TABLE 1

| | First Feedstock [Vol %]/ | First Feedstock [Vol %]/ |
|---|---|---|
| Compound | example 1 | example 2 |
| Metal powder | 64 | 62 |
| Binder | 33 | 35 |
| Additives | 3 | 3 |

TABLE 2

| | Feedstock 1 [Vol %]/ | Feedstock 2 [Vol %]/ |
|---|---|---|
| Compound | example 1 | example 2 |
| Metal powder | 56 | 52 |
| Binder | 42 | 45 |
| Additives | 2 | 3 |

Feedstocks 1 and 2 were coextruded using a flat die coextruding machine, a nozzle temperature of around 190° C., and screw speeds of between 20 and 40 m/min to make a 500 μm thick film green body.

Two-layer structured films were produced through co-extrusion of two different feedstocks having the same powder grain size of D50=33 μm, but the two different recipes depicted in tables 1 and 2.

The “green” PTLs were further shaped by means of rolling and calendering to obtain the final PTL shape, surface finish and thickness.

The produced bilayer structured PTLs (green part), was directly catalytically debinded and sintered, as a whole part, to obtain a strong and defect-free structured brown bodies.

These green bodies were sintered in a molybdenum furnace under either argon, vacuum or hydrogen atmosphere. The following temperature profile was utilized:
i. heating to a temperature of from 550 to 650° C. at a rate of from 2 to 7° C./min,
ii. holding at the temperature from 550 to 650° C. for 0.5 to 1.5 h,
iii. heating to a temperature of from 720 to 940° C. at a rate of 2 to 7° C./min,
iv. holding at the temperature of from 720 to 940° C. for 0.5 h to 2 h, and
v. cooling down to ambient temperature at a rate of from 5 to 15° C./min.

The results are shown in table 3.

TABLE 3

| | First Feedstock/ | Second Feedstock/ |
|---|---|---|
| | Layer | Layer |
| PTL Porosity [%] | 34 | 40 |
| Pore size | 8 | 27 |
| diameter [μm] | | |

### Example 2

Ti-metal powders with a powder grain size of D50=33 μm and D50=70 μm were procured for the first and second feedstock, respectively.

This powder was converted into feedstocks by mixing/compounding them with liquid additive and binder using a co-rotating twin-screw extruder. The compositions of the first and second feedstocks are shown in tables 4 and 5, respectively.

TABLE 4

| | First Feedstock [Vol %]/ | First Feedstock [Vol %]/ |
|---|---|---|
| Compound | example 1 | example 2 |
| Metal powder | 63 | 52 |
| Binder | 34 | 46 |
| Additives | 3 | 2 |

TABLE 5

| | Second Feedstock [Vol %]/ | Second Feedstock [Vol %]/ |
|---|---|---|
| Compound | example 1 | example 2 |
| Metal powder | 58 | 52 |
| Binder | 40 | 47 |
| Additives | 2 | 1 |

Feedstocks 1 and 2 were coextruded using a flat die coextruding machine, a nozzle temperature of around 210° C., and screw speeds of between 10 and 40 m/min to make a 400 μm thick film green body.

Two-layer structured films were produced through co-extrusion of two different feedstocks having the different powder grain size of D₅₀=33 μm and D₅₀=70 μm, as well as two different recipes depicted in tables 3 and 4.

These green bodies were further shaped by means of rolling and calendering to obtain the final PTL shape, surface finish and thickness.

The produced bilayer structured green bodies, was directly catalytically debinded and sintered, as a whole part, to obtain a strong and defect-free structured brown bodies.

These green bodies were sintered in a molybdenum furnace under vacuum with a pressure of 104 mbar or below. The following temperature profile was utilized:
i. heating to a temperature of from 550 to 650° C. at a rate of from 2 to 7° C./min,
ii. holding at the temperature from 550 to 650° C. for 0.5 to 1.5 h,
iii. heating to a temperature of from 875 to 1000° C. at a rate of 2 to 7° C./min,
iv. holding at the temperature of from 875 to 1000° C. for 1 h to 4 h, and
v. cooling down to ambient temperature at a rate of from 5 to 15° C./min.

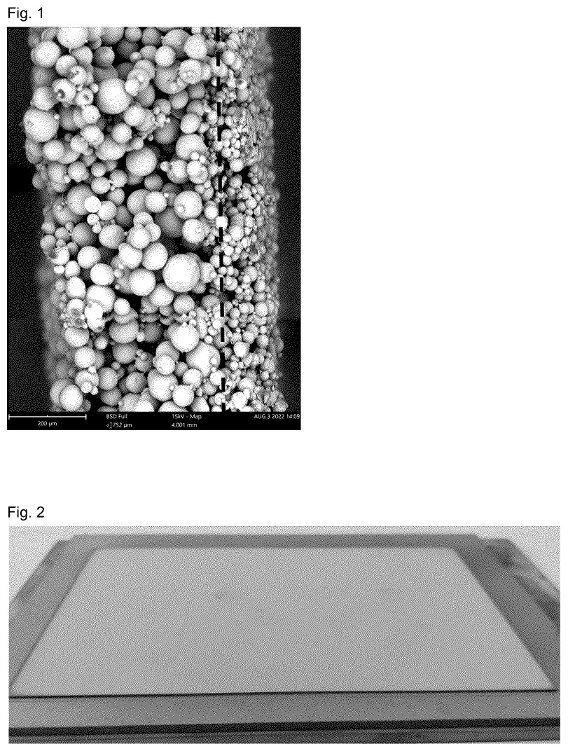

The resulting PTL is shown in FIG. 1. It shows a cross-section SEM picture of a sintered bilayer PTL showing a smooth interface between the two layers. The first layer (in contact with the catalyst layer) is based on feedstock with titanium powder of D50=33 μm and a layer thickness of 100 μm, and a second layer on top is based on feedstock with with titanium powder of D50=70 μm and a layer thickness of 380 μm. The total bilayer PTL thickness is 480 μm±25 μm. The smooth transition phase is highlighted by a dashed line.

FIG. 2 shows the final sintered bilayer PTL that has a smooth surface and a thickness tolerance of <±25 μm and is defect free.

1.-16. (canceled)

17. A process for manufacturing a multilayered porous transport layer, the process comprising
(a) providing a first feedstock comprising first metal particles and a first polymer binder; and providing a second feedstock comprising second metal particles and a second polymer binder;
the first and the second feedstock having a metal powder content of 40 to 70% by volume; and
the first feedstock having
(i) metal particles with a smaller average particles size,
(ii) a higher metal powder content, or
(iii) both, metal particles with a smaller average particles size and a higher metal powder content
compared to the second feedstock;
(b) coextruding the first and the second feedstock to form a film-shaped green body comprising a first layer and a second layer, the second layer being materially connected to the first layer at temperatures above the melting temperature and or glass transition temperature of the first polymer binder and the second polymer binder;
(c) optionally smoothing the film-shaped green body by rolling or calendering;
(d) debinding the film-shaped green body to form a brown body;
(e) sintering the brown body under a non-oxidative atmosphere or vacuum and a temperature of from 700 to 1100° C. to form the porous transport layer;
wherein the first feedstock and the second feedstock are free of any solvents.

18. The process according to claim 17, wherein the first average particle size is of from 15 to 35 μm and the second average particle size is of from 25 to 45 μm.

19. The process according to claim 17, wherein the amount of the first metal powder in the first feedstock is from 54 to 65% by volume and the amount of the second metal powder in the second feedstock is from 48 to 56% by volume.

20. The process according to claim 17, wherein the first and the second metal particles consist of titanium or stainless steel.

21. The process according to claim 17, wherein the first feedstock and the second feedstocks have a melt flow rate between 50 to 700 g/10 min, according to ISO 1133 at 190° C. and 21.6 kg.

22. The process according to claim 17, wherein the first polymer binder, the second polymer binder, or both the first and the second polymer binder have a melt flow rate MFR according to ISO 1133-1 using 190° C. and 2.16 kg of 1 to 5 g/10 min.

23. The process according to claim 17, wherein the first polymer binder, the second polymer binder, or both the first and the second polymer binder comprise
(i) 35 to 55% by volume of a polyoxymethylene;
(ii) 2 to 10% by volume of a polyolefin;
(iii) optionally 2 to 20% by volume of a further polymer; and
(iv) optionally 0.5 to 5% by volume of a dispersant.

24. The process according to claim 17, wherein the coextrusion is performed at a melt temperature of 175 to 220° C.

25. The process according to claim 17, wherein in the coextrusion step (c) a third layer is coextruded on top of the first or the second layer.

26. The process according to claim 17, wherein a smoothing is performed by rolling, calendering, or both rolling and calendering.

27. The process according to claim 17, wherein the debinding step (d) is performed in a gaseous acid comprising atmosphere.

28. The process according to claim 17, wherein the debinding step (d) comprises a catalytic debinding at a temperature of from 100 to 140° C.

29. The process according to claim 24, wherein the sintering step (e) is performed at temperatures of from 700 to 1000° C.

30. A combination of a first feedstock and a second feedstock,
(a) the first feedstock comprising first metal particles and a first polymer binder;
(b) the second feedstock comprising second metal particles and a second polymer binder;
the first feedstock having
(i) metal particles with a smaller average particles size,
(ii) a higher metal powder content, or
(iii) both, metal particles with a smaller average particles size and a higher metal powder content
compared to the second feedstock; and
wherein the melt flow rate MFR according to ISO 1133-1 using 190° C. and 2.16 kg of the first and the second polymer binder is from 1 to 5 g/10 min.

31. A film-shaped green body obtained by performing steps (a) to (d) of the process according to claim 17.

32. A porous transport layer obtainable by the process according to claim 17.
